(19) United States
(12) Patent Application Publication
(10) Pub. No.: US 2003/0088521 A1
(43) Pub. Date: May 8, 2003

(54) Method of and apparatus for managing privilege points, and computer product

(75) Inventors: Toshihiro Kodaka, Kawasaki (JP); Yoshiaki Imajima, Tokyo (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/095,564

(22) Filed: Mar. 13, 2002

(30) Foreign Application Priority Data
Nov. 6, 2001 (JP) 2001-340393

(51) Int. Cl. H04K 1/00; H04L 9/00; G06F 17/60

(52) U.S. Cl. 705/76

(57) ABSTRACT

ID informing described in a receipt which is issued by a store and obtained by a user is input from a user terminal apparatus and sent to a point server through a network. The point server request sales informing in the store from the POS server based on the received receipt ID information. The POS server receives the sales informing from the store, and accumulates privilege point information. The POS server sends the privilege point information in accordance with a request from the point server. The point server adds (totalizes) the received privilege point information to the currently accumulated privilege points of the user.

### FIELD OF THE INVENTION

The present invention relates to a technology for managing privilege points which are obtained by a user when the user buys a commodity or receives service and which gives the user various privileges in accordance with the number of accumulated points.

### BACKGROUND OF THE INVENTION

In recent years, as service to enhance a rate of repetitive coming rate of customers and to increase the number of regular customers, point service which issues the privilege point is frequently carried out. This service has become central existence as sales promotion measure especially in airline companies, large-sized electricity stores, restaurants and the like. This motion has spread also on the Internet, and a point-exchange system in which points can be exchanged between different stores is also generated.

Conventionally, in the instance of privilege points which are issued when a customer buys a commodity or receives service in a store, a card such as a point card and a stamp card is used as unit which accumulates and utilizes the privilege points is used. Generally, the card is of a magnetic recording type. Further, there is a thermo-rewrite card in which the card is provided on its surface with a special thermoplastic layer and if the card is heated, picture, character or number can be rewritten repeatedly. The accumulated or utilized point number can be visible by employing this thermo-rewrite card.

In the conventional point system, however, it is necessary to show the card when at the time of payment of the price in a store. Therefore, there is a problem that if the customer (user) left the card in his or her home, a privilege point is not added (accumulated). If the customer left the card in his or her home, the privilege point is not added (accumulated). For this reason, there is a problem that a user restrains from buying in some cases, and there is a problem that sales are not increased on the side of the store.

Not only because it is necessary to show the card at the time of payment of the price in the store, but also because different stores issue different cards, a user must carry many cards for each of stores. Therefore, there is a problem that it is troublesome for a user to carry many cards, loss or damage of card is generated because a user must carry the cards and thus, the user can not utilize the accumulated points.

The points are usually accumulated and utilized at a checkout at the time of payment of the price. Thus, it takes time to process of accumulation and utilization of the points, in addition to time required for normal payment, which generates congestion at a checkout.

There is an adverse possibility that the points are not precisely accumulated due to error of accumulation procedure. In that case, the error may not be corrected sufficiently, or if the error can be corrected, it is difficult to request the correction, in many cases. Thus, there is a problem that the service for customers may cause deterioration of reliability of the customers contrariwise for the store side.

### SUMMARY OF THE INVENTION

It is an object of the present invention to provide a method of and an apparatus for managing privilege points capable of effectively administering and making use of privilege point service by managing the service such that the privilege points can easily, efficiently and reliably be accumulated and utilized. It is another object of this invention to provide a computer program which realizes the method according to the present invention on a computer.

According to one aspect of the present invention, personal information of the user and receipt ID information described in a receipt obtained by the user when the user buys the commodity or receives the service is input. Further, privilege point information of the user is acquired based on the input personal information, and privilege point information of the receipt is acquired based on the input receipt ID information. Finally, the privilege point information of the user is changed based on the privilege point information of the receipt.

According to another aspect of the present invention, personal information of the user is input, privilege point information of the user is acquired based on the input personal information, and the user is informed of the number of usable points based on the acquired privilege point information of the user. Further, the user inputs use-desiring information including the number of points that the user desires to use within a limit of the informed number of usable points. Privilege point utilizing ID information is issued in correspondence to the input use-desiring information. Further, the issued privilege point utilizing ID information is input, and the privilege point information of the user obtained is changed based on the use-desiring information corresponding to the input privilege point utilizing ID information.

According to the present invention, a user him-self or herself can accumulate the privilege points using the personal information processing apparatus after the user bought a commodity or received service, and it is possible to make a reservation to use the accumulated privilege points using the personal information processing apparatus. Accordingly, a store need not issue a dedicated card for accumulating the points (point card), and a user need not carry such a point card.

Other objects and features of this invention will become apparent from the following description with reference to the accompanying drawings.

### BRIEF DESCRIPTION OF THE DRAWINGS

FIG. 1 is an explanatory view which shows an outline of an embodiment of the present invention,

FIG. 2 is an explanatory view which shows another outline of the embodiment of the invention,

FIG. 3 is a block diagram which shows one example of a hardware structure of a user terminal apparatus and a point server (computer) of the embodiment of the invention,

FIG. 4 is a block diagram which shows a functional structure of the point server of the embodiment of the invention,

FIG. 5 is an explanatory view which shows a sequence of accumulation processing of privilege points in a privilege point managing method of the embodiment of the invention,

FIG. 6 is an explanatory view which shows one example of a log-in screen of the embodiment of the invention,

FIG. 7 is an explanatory view which shows one example of a menu screen of the embodiment of the invention,

FIG. 8 is an explanatory view which shows one example of a store number/receipt number input screen of the embodiment of the invention,

FIG. 9 is an explanatory view which shows one example of a receipt of the embodiment of the invention,

FIG. 10 is an explanatory view which shows one example of a number of privilege point display screen of the embodiment of the invention,

FIG. 11 is an explanatory view which shows one example of a number of privilege point history screen of the embodiment of the invention,

FIG. 12 is a flowchart which shows procedure of the point server in point accumulation processing of the embodiment of the invention,

FIG. 13 is an explanatory view which shows a sequence of privilege point utilizing processing of the embodiment of the invention,

FIG. 14 is an explanatory view which shows one example of a using point input screen of the embodiment of the invention,

FIG. 15 is an explanatory view which shows one example of a point utilizing number display screen of the embodiment of the invention,

FIG. 16 is a flowchart which shows procedure of the point server in privilege point utilizing processing of the embodiment of the invention,

FIG. 17 is an explanatory view which shows one example of a store menu screen of the embodiment of the invention,

FIG. 18 is an explanatory view which shows one example of a usable point number display screen of the embodiment of the invention,

FIG. 19 is a flowchart which shows another procedure of the point server in the privilege point utilizing processing of the embodiment of the invention,

FIG. 20 is an explanatory view which shows a sequence of download processing of purchase information of the embodiment of the invention,

FIG. 21 is an explanatory view which shows a sequence of adjusting processing of privilege point source material of the embodiment of the invention,

FIG. 22 is an explanatory view which shows another sequence of adjusting processing of privilege point source material of the embodiment of the invention, and

FIG. 23 is an explanatory view which shows one example of concrete contents of the adjusting processing of the source material of the embodiment of the invention.

### DETAILED DESCRIPTIONS

Embodiments of the method of and the apparatus for managing privilege points, and the computer program according to the present invention will be explained in detail with reference to the accompanying drawings below.

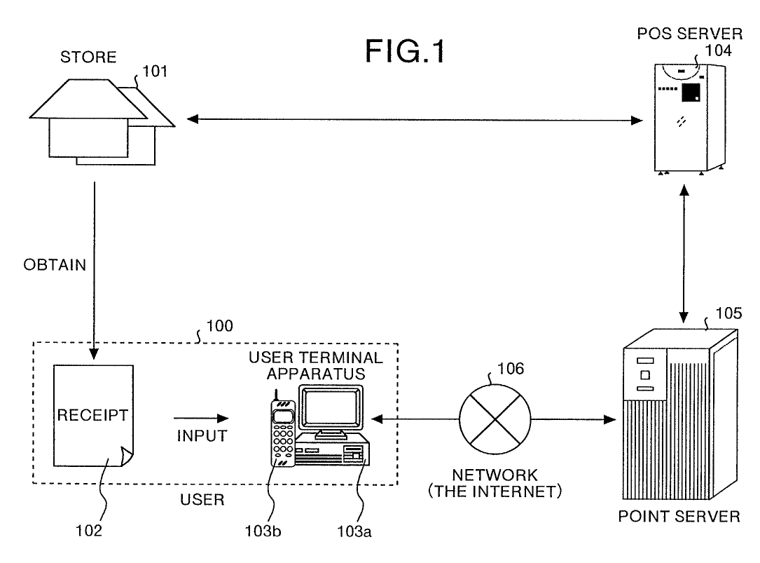

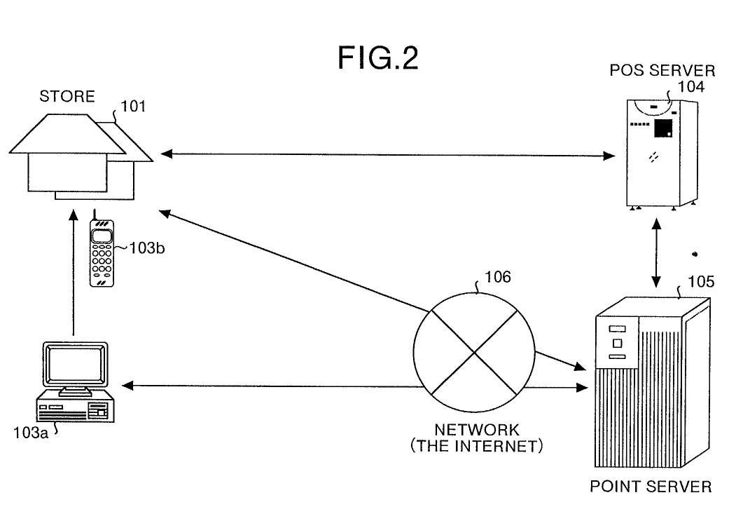

First, an outline of an embodiment of the present invention will be explained. FIGS. 1 and 2 show the outline of the embodiment of the invention. In FIGS. 1 and 2, a reference numeral 100 represents a user who uses a privilege point (the user 100 is omitted in FIG. 2), a reference numeral 101 represents a store which issues a privilege point. A reference numeral 102 represents a receipt 102 issued by the store 101 and received by the user 100, a reference numeral 103 represents a user terminal apparatus (a personal computer 103a and a cellular phone (including a portable information terminal apparatus such as PDA) 103b. A reference numeral 104 represents a POS server which manages sales information of the respective stores 101, a reference numeral 105 represents a which manages the privilege point, and a reference numeral 106 represents a network including the Internet.

Privilege points are obtained by user when the user buys a commodity or receives service. That is, privilege points are the points obtained by the user 100 in correspondence with compensation (price) which is caused when the user 100 buys a commodity from the store 101 or when the user receives service from the store 101. The privilege point may be caused when the user buys a commodity or receives service, or may be a so-called privilege point obtained by a user depending upon the number of visit to the store or the number of purchases of commodities. Further, an interest point which is periodically given to the user such as an interest, with respect to the accumulated privilege points may be included in the privilege points.

Various privileges are given to the user 100 in accordance with the number of points of the privilege points. As one example of the various points, a price to be paid is discounted in accordance with the number of obtained points when the user buys a commodity or receives service next time. More specifically, 1 point is converted into 1 yen (the currency is not limited to yen), and this amount can be discounted when the user buys a commodity next time. A present or service may be given to the user in accordance with the number of points. An example of such present or service is mileage service in which a free airplane ticket is given to the user when the number of points reaches a predetermined value.

FIG. 1 shows an outline when the privilege points are accumulated. In FIG. 1, ID information of a receipt 102, e.g., a receipt issuing store number or a receipt ID number (details of the contents will be described in detail latter) described in the receipt 102 which is issued by the store 101 and received by the user 100 is input by the user 100 from the user terminal apparatus 103 (personal computer 103a or the cellular phone 103b). Then, the user terminal apparatus 103 sends the number information input (receipt ID information) to the point server 105 through the network 106 (details of the procedures of sending will be described in detail latter).

The point server 105 requests the sales information in the store from the POS server 104 based on the receipt ID information input (received) through the network 106. The POS server 104 receives the sales information from the store 101 by a POS system which is a known technique, and accumulates the sales information, and privilege point information.

The POS server 104 sends applicable information among the sales information (or privilege point information, or both the sales information and the privilege point information) to the point server 105 in reply to the request from the point server 105. Then, the point server 105 adds (totalizes) the received privilege point information to the user's privilege points which have been accumulated currently. Alternatively, the point server 105 calculates privilege points which are to be added or totalized from the received sales information, and adds (totalizes) the calculated privilege points to user's privilege points which have been accumulated currently.

The accumulated privilege point information can be sent to the user terminal apparatus 103 through the network 106, and it is possible to inform the user 100 of the number of accumulated privilege points. In this manner, with the receipt 102 obtained when the user 100 buys a commodity or receives service at the store 101, the user 100 can accumulate the privilege points using the user terminal apparatus 103 owned by the user 100 any time.

FIG. 2 shows an outline when the privilege point is utilized. In this embodiment, a so-called point card which was conventionally required when the privilege point is utilized does not exist. Therefore, there is a unit (or method) which informs a (salesclerk) of the store 101 that the privilege points are accumulated when the user 100 visits the store 101 next time and utilizes the privilege point. In FIG. 2, when the privilege point is utilized, the user 100 first accesses the point server 105 through the network 106 using the user terminal apparatus 103.

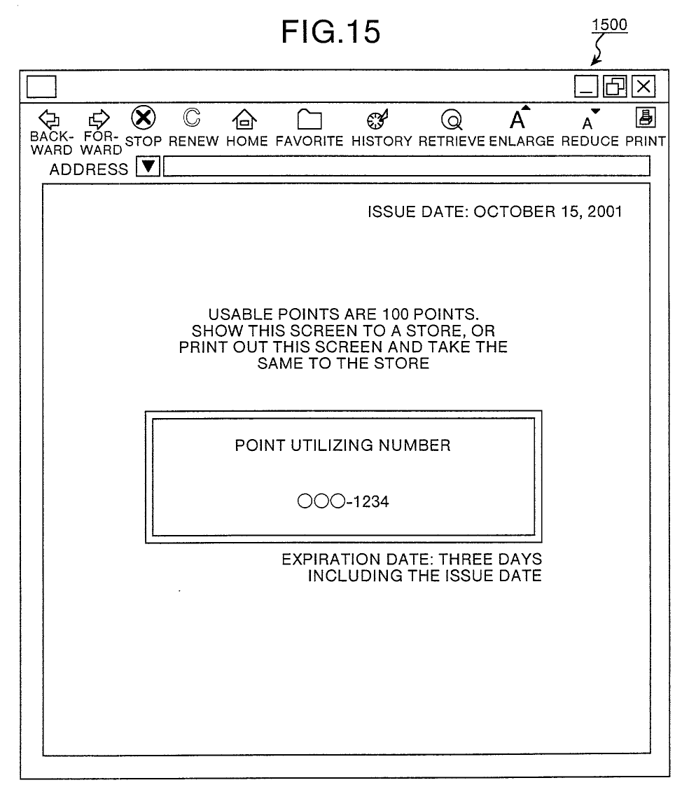

The number of privilege points to be used is previously shown to make a reservation to use the privilege points. Image information concerning the number of privilege points required to make the reservation to use the privilege points is obtained from the point server 105 (see later-described FIG. 15). Then, in the store, the image information is shown or printed image information is shown. The store 101 accesses the point server 105 through the network 106 or the POS server 104 based on the image information, and confirms the use of the number of reserved points shown in the image information, with respect to the point server 105.

The point server 105 adjusts (subtracts) the reserved points in accordance with the confirmation processing, and informs the POS server 104 that the service of the number of privilege points was supplied, and changes (subtracts) the number of accumulated privilege points. In this manner, the user 100 can easily use the accumulated privilege points without showing the screen of the cellular phone 103b or a printed display screen of the personal computer 103a to a (salesclerk of) the store 101 without carrying the point card.

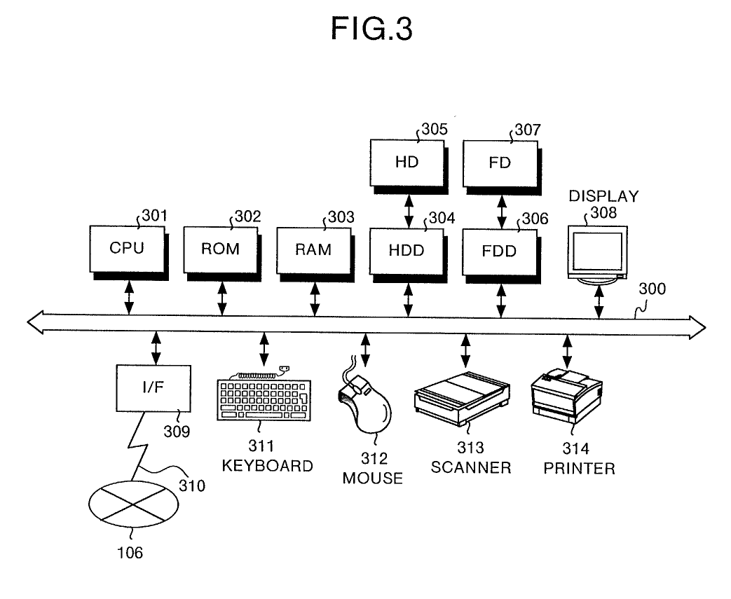

The hardware structure of the user terminal apparatus, the POS server, and the point server will now be explained. The user terminal apparatus 103, the POS server 104 and the point server 105 which realize the contents of the embodiment of the invention will be explained. FIG. 3 is a block diagram which shows one example of a hardware structure of a computer (information processing apparatus (portable type information processing apparatus)) which constitutes the user terminal apparatus 103, the POS server 104 and the point server 105.

In FIG. 3, the hardware structure of the user terminal apparatus 103 and the point server 105 includes a CPU 301, a ROM 302, a RAM 303, a HDD (hard disk drive) 304, a HD (hard disk) 305, a FDD (floppy disk drive) 306, a FD (floppy disk) 307 as one example of a removable storage medium, a display 308, an I/F (interface) 309, a keyboard 311, a mouse 312, a scanner 313 and a printer 314. The above constituent elements are connected to each other through a bus 300.

The CPU 301 controls the entire information providing apparatus. The ROM 302 stores therein programs such as a boot program. The RAM 303 is used as a working area of the CPU 301. The HDD 304 controls read/write of data from and to the HD 305 under the control of the CPU 301. The HD 305 stores therein data which was written under control of the HDD 304.

The FDD 306 controls read/write of data from and to the FD 307. The FD 307 stores therein data which was written under control of the FDD 306, and allows an information processing apparatus to read data which was stored in the FD 307. The removable storage medium may be CD-ROM (CD-R, CD-RW), MO, DVD (Digital Versatile Disk), memory card and or the like, in addition to the FD 307. The display 308 displays a window (browser) concerning data such as cursor, icon, tool box, character, image and function information. Examples of the display 308 are CRT, TFT liquid crystal display, plasma display and the like.

The I/F 309 is connected to the network 106 such as LAN and the Internet through a communication line 310, and connected to another information processing apparatus (e.g. server) through the network 106. The I/F 309 controls interface between the network 106 and the interior, and controls input and output of data from another server or information processing apparatus. Examples of the I/F 309 are modem and the like. When the user terminal apparatus 103 carries out radio communication with the cellular phone 103b or the like, the I/F 309 includes a function as a communication device (radio transceiver).

The keyboard 311 includes keys to input character, numeric, various commands, and inputs data. The keys may be a touch-panel type input pad or a numeric keypad. The mouse 312 moves a cursor, selects a range, or moves a window and changes a size. A trackball, a joystick, a cross key, a jog dial may be used as the mouse 312 only if it includes the same function as a pointing device.

The scanner 313 optically reads an image, and captures image data into the information processing apparatus. The printer 314 prints the image data or text data. Examples of the printer 314 are laser printer, ink jet printer and the like.

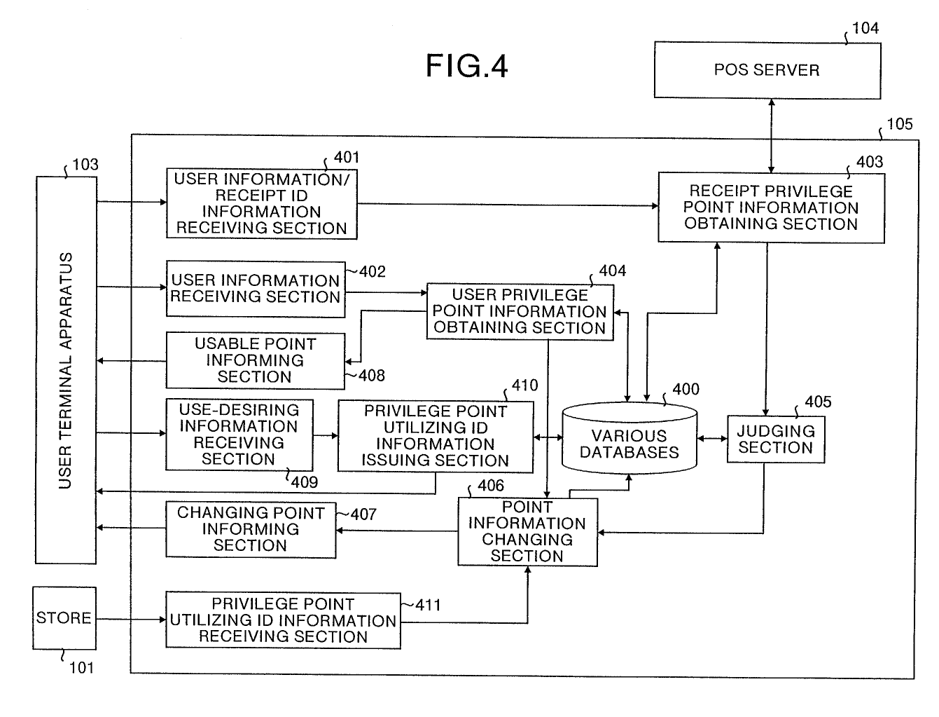

A functional structure of the point server of the embodiment of the present invention will be explained. FIG. 4 is a block diagram which shows a functional structure of the point server of the embodiment of the invention. In FIG. 4, the point server 105 comprises a various databases 400, a user information/receipt ID information receiving section 401, a user information receiving section 402, a receipt privilege point information obtaining section 403, a user privilege point information obtaining section 404, a judging section 405, a point information changing section 406, a changing point informing section 407, a usable point informing section 408, a use-desiring information receiving section 409, a privilege point utilizing ID information issuing section 410 and a privilege point utilizing ID information receiving section 411.

Information required to accumulate and utilize the privilege points such as the personal information, the privilege point information and the like are stored in the various databases 400. The various databases 400 realizes its function by writable storage medium such as the RAM 303, the HD 305, the FD 307 and the like shown in FIG. 3 for example.

The user information/receipt ID information receiving section 401 receives receipt ID information (such as later-described store number/receipt number) shown in the receipt 102 obtained by the user 100 when the privilege point is accumulated and when the user buys a commodity or receives service, from the user terminal apparatus 103 through the network 106. The user information/receipt ID information receiving section 401 realizes its function by the I/F 309 shown in FIG. 3 for example.

The user information receiving section 402 receives the personal information (such as later-described membership number and password) from the user terminal apparatus 103 through the network 106 when the privilege point is accumulated and before the privilege point is utilized. The user information receiving section 402 realizes its function by the I/F 309 shown in FIG. 3 for example.

The receipt privilege point information obtaining section 403 obtains the privilege point information (the number of privilege points) of the receipt 102 from the POS server 104 through the network 106, based on the receipt ID information received by the user information/receipt ID information receiving section 401 when the privilege point is accumulated. More specifically, the receipt privilege point information obtaining section 403 sends the receipt ID information to the POS server 104 through the network 106, and receives the privilege point information from the POS server 104 through the network 106 as will be described later.

The receipt privilege point information obtaining section 403 may obtain the sales information of the receipt 102 from the POS server 104, and may calculate the number of privilege points based on the sales information. With this, the POS server 104 need not manage the privilege point information. Alternatively, the point server 105 may change the rate of the number of privilege points given to the sales. The receipt privilege point information obtaining section 403 realizes its function by the I/F 309 and the like shown in FIG. 3 or if the CPU 301 executes the programs stored in the ROM 302, the RAM 303, the HD 305, the FD 307 and the like shown in FIG. 3 for example.

The user privilege point information obtaining section 404 obtains the privilege point information of the user 100 from the database 400 based on the personal information received by the user information receiving section 402 when the privilege point is accumulated and before the privilege point is utilized. The user privilege point information obtaining section 404 realizes its function if the CPU 301 executes the programs stored in the ROM 302, the RAM 303, the HD 305, the FD 307 and the like shown in FIG. 3. When the database 400 is provided outside, the user privilege point information obtaining section 404 realizes its function by the I/F 309 and the like shown in FIG. 3 for example.

The judging section 405 judges whether the privilege point information of the user 100 obtained by the user privilege point information obtaining section 404 has already been changed by the point information changing section 406, by accessing the database 400, based on the privilege point information of the receipt 102 obtained by the receipt privilege point information obtaining section 403 when the privilege point is accumulated. The judging section 405 realizes its function if the CPU 301 executes the programs stored in the ROM 302, the RAM 303, the HD 305, the FD 307 and the like shown in FIG. 3.

The point information changing section 406 changes (totalizes) the privilege point information of the user 100 obtained by the user privilege point information obtaining section 404 based on the privilege point information of the receipt obtained by the receipt privilege point information obtaining section 403 when the privilege point is accumulated. At that time, the privilege point information of the user obtained by the user privilege point information obtaining section 404 may be changed (totalized) based on the judgment result judged by the judging section 405. With this, it is possible to prevent double registration of the privilege point. The point information changing section 406 realizes its function if the CPU 301 executes the programs stored in the ROM 302, the RAM 303, the HD 305, the FD 307 and the like shown in FIG. 3.

The changing point informing section 407 informs the user 100 of the privilege point information changed by the point information changing section 406 before the privilege point is accumulated. That is, the changing point informing section 407 sends image information or sound information concerning the privilege point information to the user terminal apparatus 103 through the network 106. The changing point informing section 407 realizes its function by the I/F 309 and the like shown in FIG. 3 for example.

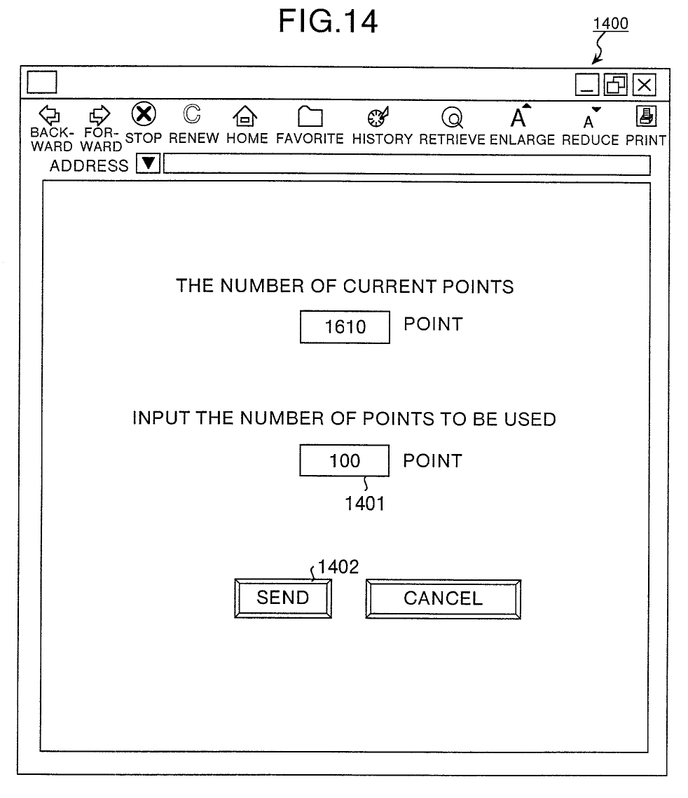

The usable point informing section 408 informs the user 100 of the number of usable points of the user 100, based on the privilege point information of the user 100 obtained by the user privilege point information obtaining section 404 before the privilege point is utilized. That is, the usable point informing section 408 sends the image information (e.g., later-described display screen shown in FIG. 14) or sound information to the user terminal apparatus 103 through the network 106. The usable point informing section 408 realizes its function by the I/F 309 and the like shown in FIG. 3 for example.

The use-desiring information receiving section 409 receives, from the user terminal apparatus 103 through the network 106, the use-desiring information (e.g., later-described number of points to be used which was input in the display screen shown in FIG. 14) including the number of points which the user 100 desires to use within a limit of the number of usable points informed by the usable point informing section 408, before the privilege point is utilized. The use-desiring information receiving section 409 realizes its function by the I/F 309 and the like shown in FIG. 3 for example.

The privilege point utilizing ID information issuing section 410 issues the privilege point utilizing ID information (point utilizing number shown in later-described FIG. 15 for example) in correspondence with the use-desiring information received by the use-desiring information receiving section 409 before the privilege point is utilized, and sends the privilege point utilizing ID information to the user terminal apparatus 103 through the network 106. The privilege point utilizing ID information issuing section 410 realizes its function if the CPU 301 executes the programs stored in the ROM 302, the RAM 303, the HD 305, the FD 307 and the like, or by the I/F 309 and the like shown in FIG. 3.

The privilege point utilizing ID information receiving section 411 receives the privilege point utilizing ID information issued by the privilege point utilizing ID information issuing section 410 from the (terminal apparatus of) the store 101, when the privilege point is utilized. The privilege point utilizing ID information receiving section 411 realizes its function by the I/F 309 and the like shown in FIG. 3. At that time, the point information changing section 406 changes the privilege point information of the user obtained by the privilege point information obtaining unit based on the use-desiring information which corresponds to the privilege point utilizing ID information received by the privilege point utilizing ID information receiving unit. The point information changing section 406 realizes its function by the I/F 309 and the like shown in FIG. 3.

In the above description, the point server 105 shown in FIG. 4 realized using one computer having the hardware structure shown in FIG. 3 for example, but the point server 105 is not limited to this structure, and a plurality of servers may be connected to each other through LAN or the Internet, and functions of the respective constituent sections may be dispersed to the respective servers.

In FIG. 4, the point server 105 includes the various databases 400, but the point server 105 is not limited to this structure, and various databases 400 may be connected to each other through the network such as LAN or the Internet. In that case, an interface to access the various databases 400 through the network are provided in the point server 105.

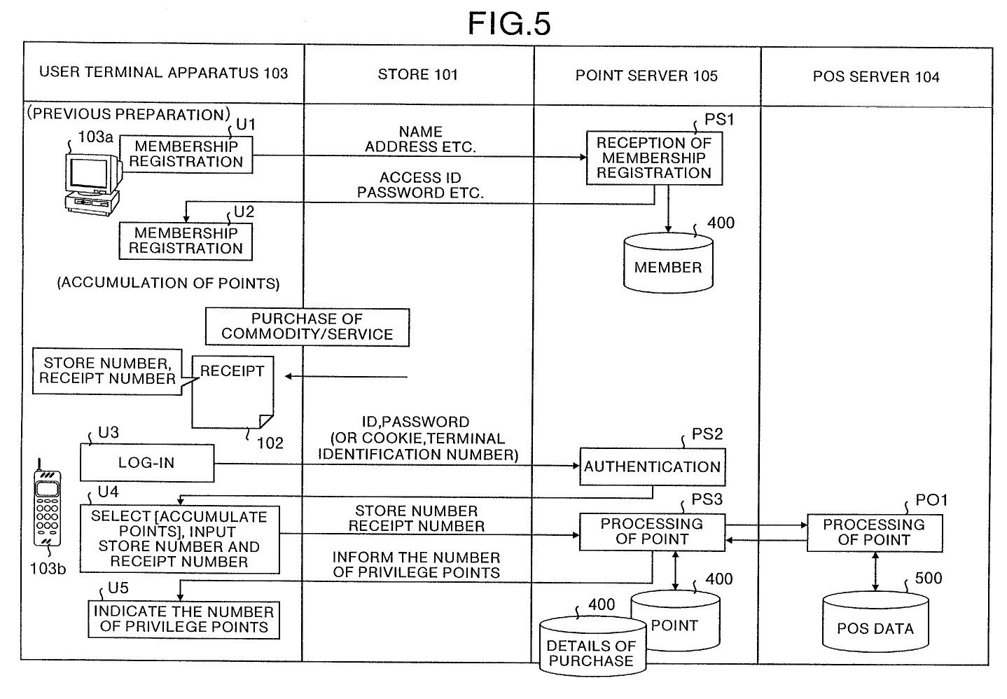

Contents of accumulating processing of the privilege point of the privilege point managing program of the embodiment of the invention will be explained. FIG. 5 is an explanatory view which shows a sequence of the accumulating processing of the privilege point. In FIG. 5, as a preliminary preparation, procedure of membership register is carried out using the user terminal apparatus 103 (U1). More specifically, a membership register screen (not shown) is displayed, membership rule and the like are shown, and general information including name, address, phone number, mail address, liaison are input.

In the point server 105, reception processing of membership register is carried out based on information concerning the general information including name and liaison (PS1). Then, upon the membership register, an access ID (membership number) and password are sent to the user terminal apparatus 103, and information of received member is registered in the database 400. In the user terminal apparatus 103, if the sent membership number and password are received, information meaning that the membership register was completed is displayed (U2).

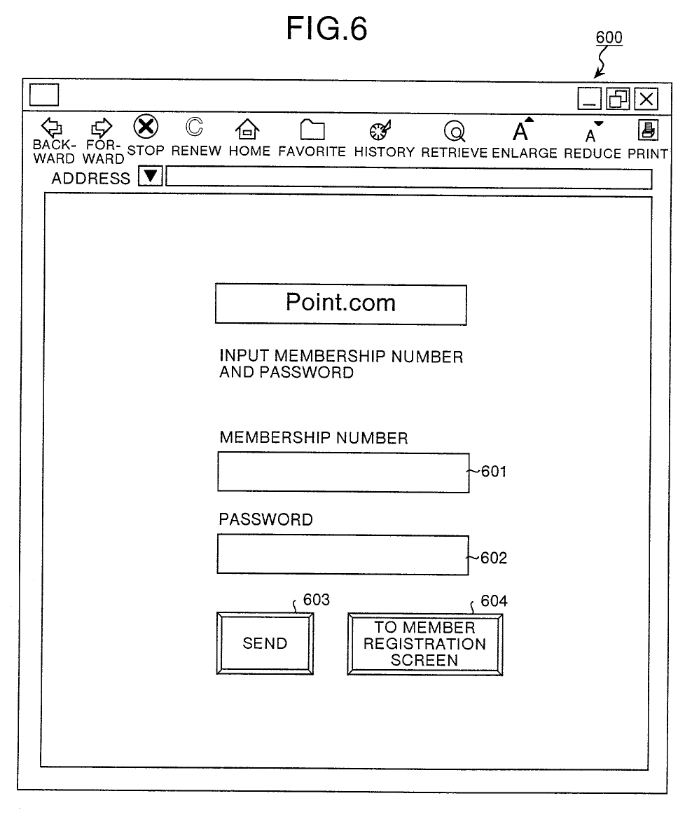

Based on the receipt 102 which is issued when the user buys a commodity or receives the service, the user logs in using the user terminal apparatus 103 as accumulating procedure of the privilege point (U3). More specifically, if the user accesses a predetermined site (e.g., [point.com]), a log-in screen 600 shown in FIG. 6 is displayed. FIG. 6 is an explanatory view which shows one example of the log-in screen.

In FIG. 6, a log-in screen 600 includes a membership number inputting column 601 and a password inputting column 602. A membership number and a password received at the time of the membership register procedure are input using the keyboard 311. Then, if a [send] button 603 is clicked using the mouse 312 or the like, the log-in processing is completed. At that time, cookie information or terminal identification number of the user terminal apparatus 103 may sent together. A [membership register] button 604 is provided for a user whose membership has not yet been registered. If the [membership register] button 604 is clicked, the membership register screen (not shown) can be displayed.

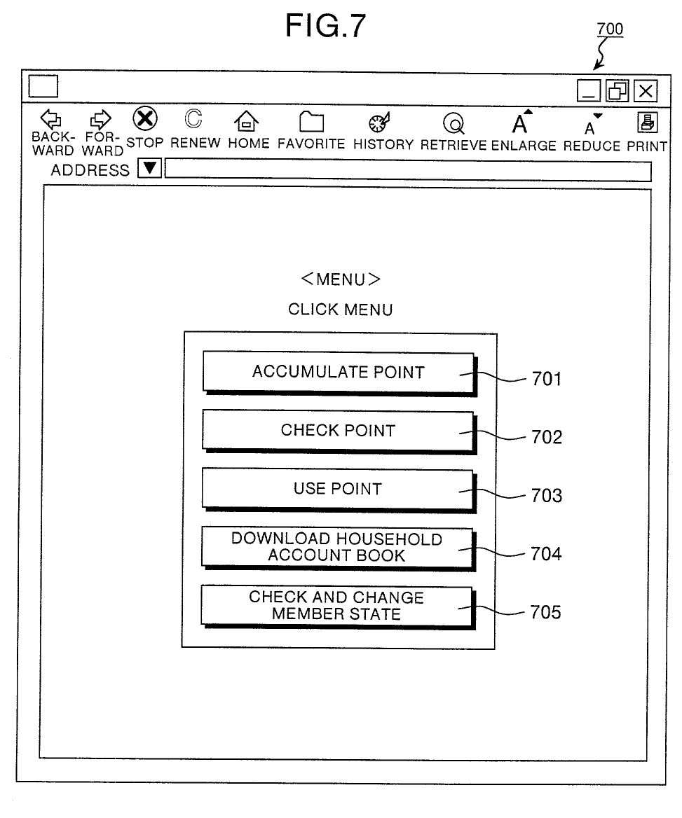

Authentication processing is carried out in the point server 105 (PS2). If the membership is authenticated, a menu screen 700 shown in FIG. 7 is sent to the user terminal apparatus 103, and the user terminal apparatus 103 displays the menu screen 700. FIG. 7 is an explanatory view which shows one example of the menu screen. As shown in FIG. 7, a [accumulate points] button 701, a [check point] button 702, a [use points] button 703, a [download household account book] button 704 and a [check/change member status] button 705 are displayed on the menu screen 700, and if one of the buttons 701 to 705 is clicked using the mouse 312 or the like, the corresponding menu is selected.

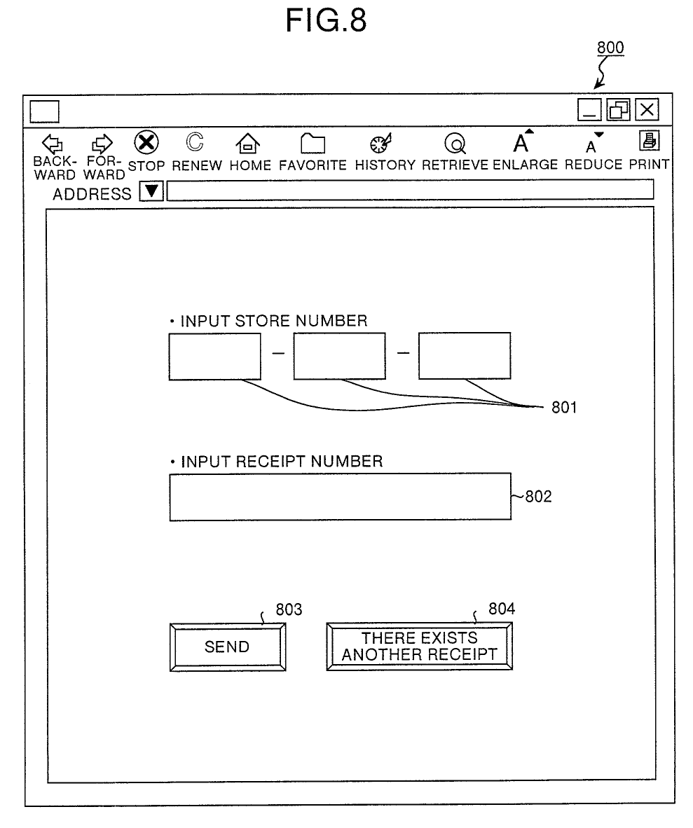

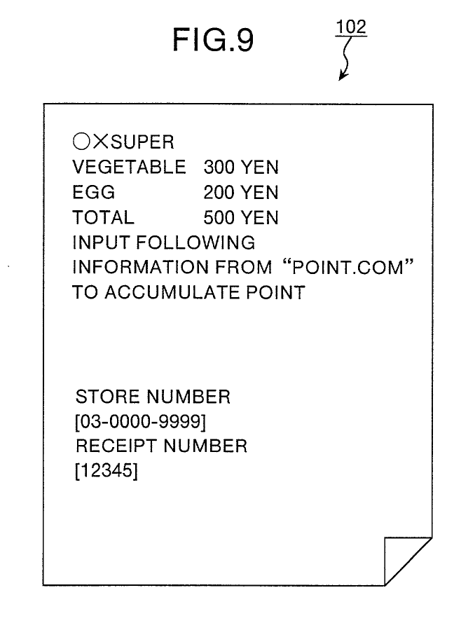

If the [accumulate points] button 701 is selected, a store number/receipt number input screen 800 shown in FIG. 8 is displayed. FIG. 8 is an explanatory view which shows one example of the store number/receipt number input screen. FIG. 9 is an explanatory view which shows one example of the receipt 102. In FIG. 8, an area 801 for inputting store number and an area 802 for inputting receipt number are displayed on the store number/receipt number input screen 800. A store number ([03-0000-9999]) and a receipt number ([12345]) described in the receipt 102 shown in FIG. 9 are input using the keyboard 311 or the like (U4).

In FIG. 8, a [send] button 803 and a [there exists another receipt] button 804 are displayed, and if the [send] button 803 is clicked using the mouse 312 or the like, the input store number/receipt number is sent to the point server 105. If the [there exists another receipt] button 804 is clicked, the area 801 for inputting store number and the area 802 for inputting receipt number are newly displayed, and store number and receipt number of another receipt 102 can be input. After the same operation is repeated, if the [send] button 803 is clicked, store numbers and receipt number of a plurality of receipts can be sent.

The point server 105 requests point information from the POS server 104 based on the received store number/receipt number. The POS server 104 carries out the point processing (P01). That is, information concerning details of the receipt 102 or information concerning the number of points issued by the receipt 102 is extracted based on the request, and the extracted information is sent to the point server 105.

In the point server 105, point processing is carried out based on and the received information and information concerning privilege point (number) of the user extracted from the database 400 (PS3). That is, the number of points issued by the receipt 102 is added to the number of privilege points of the user. Then, information concerning the accumulated number of privilege points is sent to the user terminal apparatus 103. In the user terminal apparatus 103, information concerning the received number of privilege points is displayed (U5).

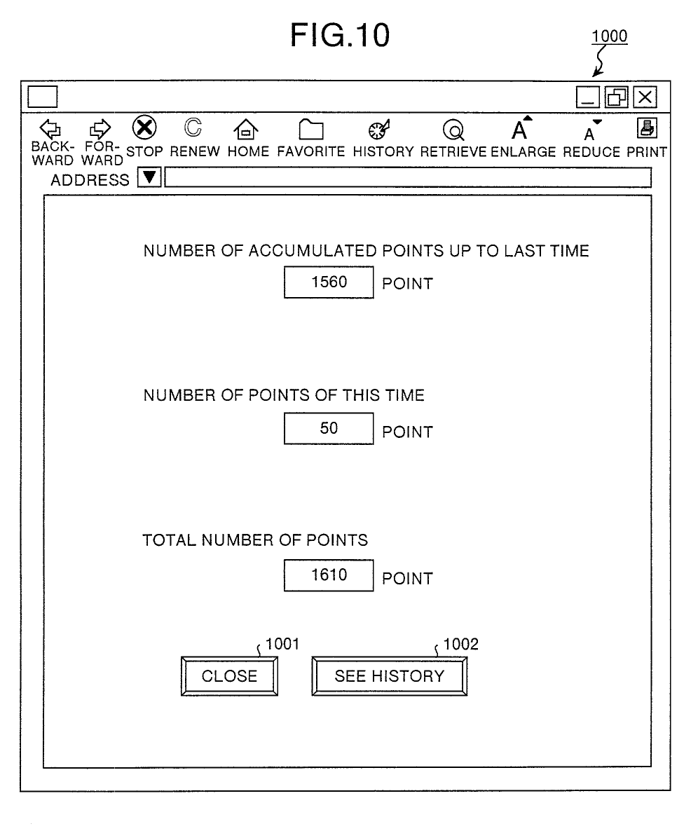

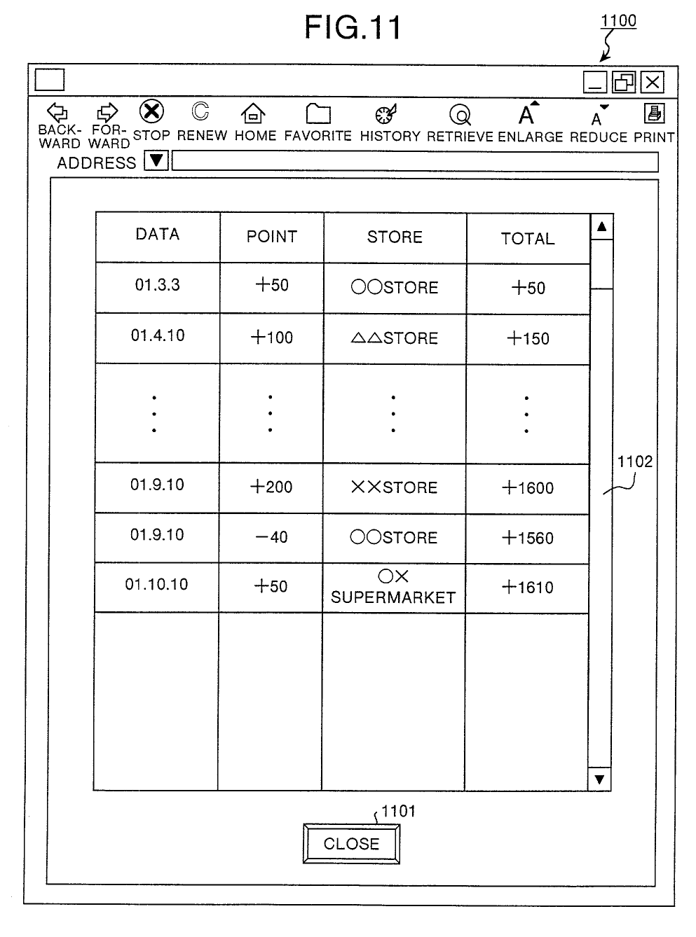

FIG. 10 is an explanatory view which shows one example of a number of privilege point display screen on which information concerning number of privilege points is displayed. In FIG. 10, the number of accumulated points ([1560] points) accumulated last time, the number of points ([50] points) accumulated this time, and total number of points ([1610] points) which is a total of the number of points are displayed n the number of privilege points display screen 1000. If the [close] button 1001 is clicked, the number of privilege points display screen 1000 is closed, and if the [see history] button 1002 is clicked, a number of privilege point history display screen 1100 shown in FIG. 11 is displayed.

FIG. 11 is an explanatory view which shows one example of a number of privilege point history screen displaying history information concerning the number of privilege points. In FIG. 11, the number of privilege point history display screen 1100 displays data when the privilege points are accumulated, the number of points, a receipt issuing store name, the total (accumulated number of points and the like in a time series in a form of a list. Like the number of privilege points display screen 1000, if the [close] button 1101 is clicked, the number of privilege point history display screen 1100 is closed. If the number of histories is large, the list of the histories can be scrolled by a scroll bar 1102. In this manner, the point accumulation processing is completed.

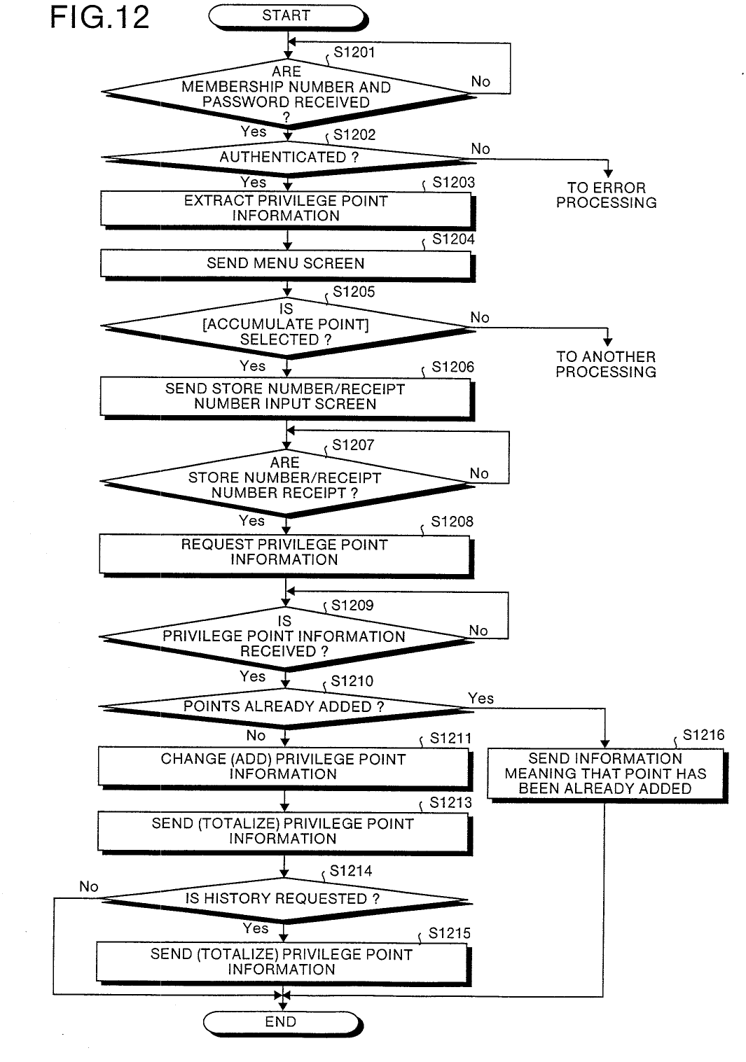

FIG. 12 is a flowchart which shows procedure of the point server in the point accumulation processing. To begin with, it is judged whether a membership number and a password are received (step S1201). This step is repeated until the membership number and the password are received. When membership number and the password are received (step S1201: Yes), the authentication processing is carried out based on the received membership number and password, and it is judged whether the member is an authentic member (step S1202). If it is decided that the member is not an authentic member (step S1202: No), known (“normal”) error processing is carried out. In this normal error processing, for example, a screen is displayed on the terminal of the user and the user is requested to input the information once more.

If it is decided that the member is an authentic member (step S1202: Yes), privilege point information of a member (user 100) corresponding to the membership number is extracted (step S1203), and menu screen 700 shown in FIG. 7 for example is sent to a user terminal apparatus 103 of the member (step S1204).

It is judged whether the [accumulate points] button 701 is selected on the menu screen 700 (step S1205). That is, it is judged whether selection information of the [accumulate points] button 701 is received or selection information of another button 702 to 704 is received (step S1205). If it is decided that the selection information of the other button 702 to 704 is received (step S1205: No), processing corresponding to the selected button is carried out. On the other hand, if it is decide that the selection information of the [accumulate points] button 701 is received, (step S1205: Yes) a store number/receipt number input screen 800 shown in FIG. 8 for example is sent to the user terminal apparatus 103 of the member (step S1206).

It is judged whether information concerning the store number and the receipt number is received (step S1207). This step is repeated until the information concerning the store number and the receipt number is received. If it is decide that the concerning the store number and the receipt number is received (step S1207: Yes), privilege point information corresponding to the storage medium and the receipt number is requested from the POS server 104 (more specifically, request information is sent to the POS server 104) (step S1208).

It is judged whether the privilege point information corresponding to the store number and the receipt number is received (step S1209). This step is repeated until the privilege point information corresponding to the store number and the receipt number are received. If it is decide that the privilege point information corresponding to the store number and the receipt number are received (step S1209: Yes), it is judged whether the privilege point information has already been added (step S1210). More specifically, past added receipt information is retrieved from the database 400, and it is judged whether corresponding information was found. The processing of this step S1210 can be omitted.

If the privilege point information has not yet been added in step S1210 (step S1210: No), privilege point (number) corresponding to the store number and the receipt number is added to the privilege point (number) information extracted in step S1203 (step S1211). Then, the accumulated privilege point (number) information is sent to the user terminal apparatus 103 (step S1213). Further, it is judged whether the history information of the privilege point was requested (step S1214). More specifically, a [see history] button 1002 shown in FIG. 10 is pushed down, and it is judged whether the information was received.

In step S1214, if the information concerning the [see history] button 1002 is received (step S1214: Yes), information concerning the number of privilege points history shown in FIG. 11 for example is sent (step S1215), and the series of processing is completed. If there is no request in step S1214 (step s1214: No), the processing is completed without doing anything. If the privilege point of the receipt 102 has already been added in step S1210 (step S1210: Yes), information that the privilege point has already been added is sent (step S1216), and the series of processing is completed.

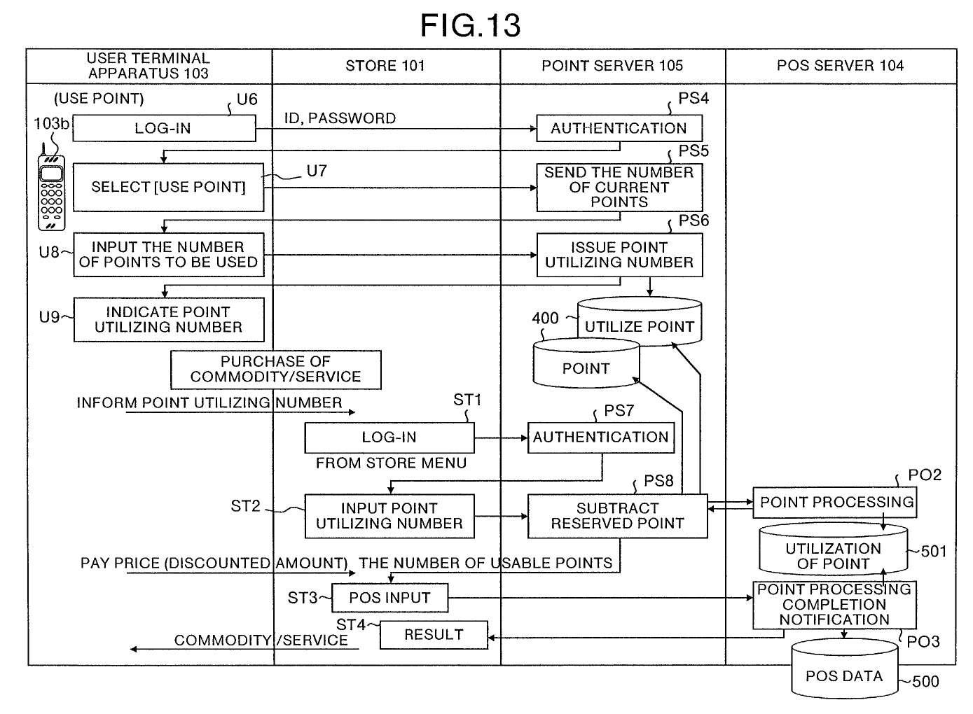

Contents of utilizing processing of the privilege points according to the embodiment of the invention will be explained. FIG. 13 is an explanatory view which shows a sequence of the privilege point utilizing processing. In FIG. 13, as procedure of utilizing the privilege point, a reservation of utilizing the privilege point is made. The user logs in to the system using the user terminal apparatus 103 (U6). More specifically, if the user accesses a predetermined site (e.g., [point.com]), the log-in screen 600 shown in FIG. 6 is displayed. Since the contents of the log-in processing is the same as the log-in processing (U3) shown in FIG. 5, explanation thereof is omitted.

The authentication processing is carried out in the point server 105 (PS4). If authenticated, the menu screen 700 shown in FIG. 7 is sent to the user terminal apparatus 103, and the menu screen 700 is displayed in the user terminal apparatus 103. Here, if the [accumulate points] button 701 is selected (U7) and the information is received, the point server 105 sends information concerning the current number of points (the number of accumulated points) of the user 100 (PS5).

The user terminal apparatus 103 receives the information, and displays a using point input screen 1400 shown in FIG. 14 for example. FIG. 14 is an explanatory view which shows one example of the using point input screen. In FIG. 14, the number of current of points ([1610] point) is displayed on the using point input screen 1400, and a number of point-to-be-used inputting column 1401 is displayed. The number of points which the user 100 desires to use is input using the keyboard 311 or the like (U8). After the number of points are input, if the [send] button 1402 is clicked using the mouse 312 or the like, the input store number/receipt number is sent to the point server 105.

The point server 105 issues a point utilizing number with respect to the received information (PS6). The point utilizing number is a number to be indicated to the store when the user 100 utilizes the number of points in the store 101, and a serial number is issued whenever use of point is requested. The information concerning the issued point utilizing number is sent to the user terminal apparatus 103. The user terminal apparatus 103 receives the informing concerning the point utilizing number, and displays a point utilizing number display screen 1500 as shown in FIG. 15 for example (U9).

FIG. 15 is an explanatory view which shows one example of the point utilizing number display screen which shows the point utilizing number, its handling and expiration date. In FIG. 15, point utilizing number ([000-1234]), the number of usable points (100 points), a handling method ([Show this screen to the store, or print out this screen and take the same to the store]), and expiration date of the point utilizing number ([three days including the issue date]) are shown in the point utilizing number display screen 1500.

The handling method differs depending upon kinds of the user terminal apparatus 103. If the user terminal apparatus 103 is portable such as the cellular phone 103b, this point utilizing number display screen 1500 is displayed on the display 308, and this point utilizing number display screen 1500 is indicated to the salesclerk of the store 101. If the user terminal apparatus 103 is not portable such as a desktop personal computer, the point utilizing number display screen 1500 is printed out, and the printed sheet of paper is brought to the store 101 and indicated to the salesclerk of the store 101. The expiration date is set while taking trading safety into account, and when the expiration date is elapsed, the point utilizing number is ineffective, and cannot be used thereafter.

Although data of the terminal apparatus of the store 101 and the point server 105 in the utilizing processing of the privilege point is sent and received through the network 106 in FIG. 13, the present invention is not limited to this, and the data of the terminal apparatus of the store 101 and the point server 105 may be sent and received through the POS server 104. In that case, the log-in processing (U6) and the authentication processing (PS4) need not be carried out.

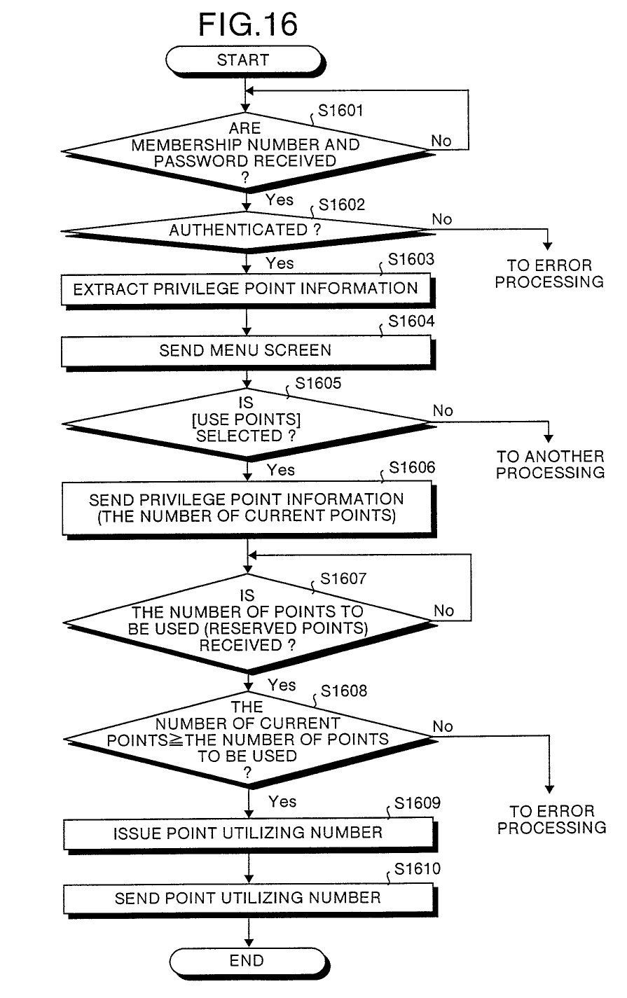

FIG. 16 is a flowchart which shows procedure of the point server 105 in privilege point utilizing processing. To begin with, it is judged whether the membership number and password are received (step S1601). This step is repeated until the membership number and the password are received. If the membership number and the password are received (step S1601: Yes), authentication processing is carried out based on the received membership number and password, and it is judged whether the member is an authentic member (step S1602). If it is decide that the member is not an authentic member (step S1602: No), the normal error processing is carried out. In the normal error processing, for example, an error screen is sent to induce the user to input again.

If it is decided at step S1602 that the member is an authentic member (step S1602: Yes), privilege point information of the member (user 100) corresponding to the membership number is extracted based on the received membership number (step S1603), and the menu screen 700 shown in FIG. 7 for example is sent to the user terminal apparatus 103 of the member (step S1604).

It is judged whether the [use points] button 703 is selected on the menu screen 700 (step S1605). That is, it is judged whether the selection information of the [use points] button 703 is received or whether or not selection information of any of the other buttons 701, 702, 704 and 705 is received (step S1605). If it is decided that the selection information of any of the other buttons 701, 702, 704 and 705 is received (step S1605: No), processing corresponding to the selected button is carried out. On the other hand, if it is decide that the selection information of the [use points] button 703 is received (step S1605: Yes), the using point input screen 1400 shown in FIG. 14 for example is sent to the user terminal apparatus 103 of the member as the privilege point information (the number of current points) (step S1606).

It is judged whether the information concerning the number of points to be used (the number of reserved points) is received (step S1607). This step is repeated until the informing concerning the number of points to be used is received. If it is decide that the informing concerning the number of points to be used is received (step S1607: Yes), it is judged whether the number of point to be used is an appropriate numeric value, i.e., whether or not (the number of current points)≧ (the number of points to be used) (step S1608).

If the condition in step S1608 is not satisfied (step S1608: No), normal error processing is carried out. More specifically, an error screen is sent to induce the user to input again. If the condition in step S1608 is satisfied (step S1608: Yes), the point utilizing number is issued (step S1609). Then, the point utilizing number is sent to the user terminal apparatus 103 of the member together with the information concerning handling of the point utilizing number and the expiration date (step S1610), and the series of processing concerning the reservation of utilizing of the number of points is completed.

Referring back to FIG. 13, the user 100 who utilizes the privilege point visits the store 101, and indicates (informs) the point utilizing number. The store 101 logs in the system using a store terminal apparatus (not shown) (ST1). More specifically, a log-in screen (not shown) is displayed by accessing a predetermined site. Contents of the log-in processing is carried out if a salesclerk of the store 101 inputs the store number and the password which are registered according to the stores 101 like the log-in processing (U3) shown in FIG. 5.

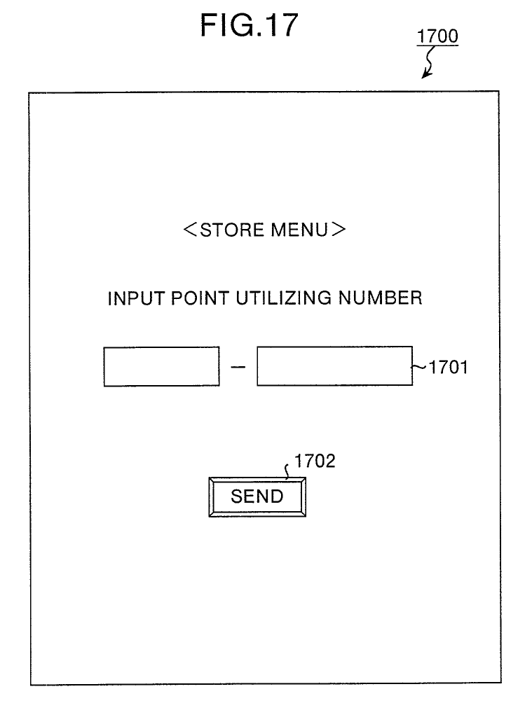

In the point server 105, the authentication processing is carried out (PS7). When authenticated, a store menu screen 1700 as shown in FIG. 17 for example is sent to the store terminal apparatus, and the store terminal apparatus displays the store menu screen 1700. FIG. 17 is an explanatory view which shows one example of the store menu screen. In FIG. 17, the point utilizing number indicated by the user 100 is input to the point utilizing number inputting column 1701 in the store menu screen 1700, and the [send] button 1702 is clicked (ST2). The point utilizing number maybe input and the [send] button 1702 maybe clicked by a salesclerk of the store 101 or directly by the user 100.

If the [send] button 1702 is clicked, the input point utilizing number is sent to the point server 105.

In the point server 105, privilege point of the user 100 corresponding to the point utilizing number is extracted from the database with respect to the received information, the number of points which was reserved in PS6 is adjusted (subtracted) from the number of privilege points, and this information (adjustment informing) is sent to the POS server 104. The number of points which is the same as the subtracted number of points is sent to the store terminal apparatus of the store 101 as the number of usable points (PS8).

In the POS server 104, the adjusted information from the point server 105 is received, and data of point utilizing database which manages the privilege point in the POS server 104 is changed (PO2).

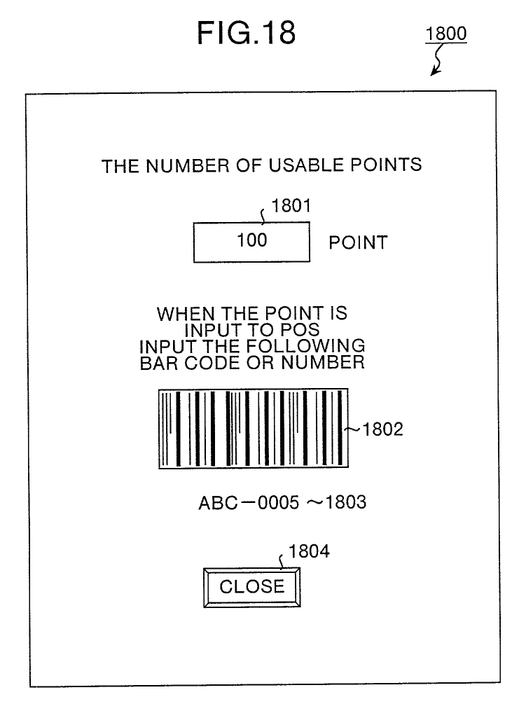

In the store 101, information concerning the number of usable points is received, and a number of usable point display screen 1800 shown in FIG. 18 for example is displayed. FIG. 18 is an explanatory view which shows one example of the usable point number display screen. In FIG. 18, the number of usable points ([100] point) is displayed in a number of usable point display column 1801 of the number of usable point display screen 1800, and a POS inputting bar code 1802 or a number (ABC-0005) 1803 are displayed on this column. When the user 100 pays the price, the salesclerk of the store 101 receives money which was reduced in accordance with the number of privilege points, and inputs the bar code 1802 to the POS system using a bar code reader of the register (not shown) or inputs (sends) using keys of the register (not shown the number 1803) (ST3).

In the POS server 104, point processing completion notification is sent based on input (received) informing read by the bar code reader or informing concerning the input number (PO3). This point processing completion notification is sent to a point utilizing database 501 and POS data 500 and accumulated. Further, the point processing completion notification is sent to the store 101, the store 101 is informed of the result (ST4), and a salesclerk of the store 101 confirms the result and then gives a commodity or service to the user 100, and the series of trading is completed.

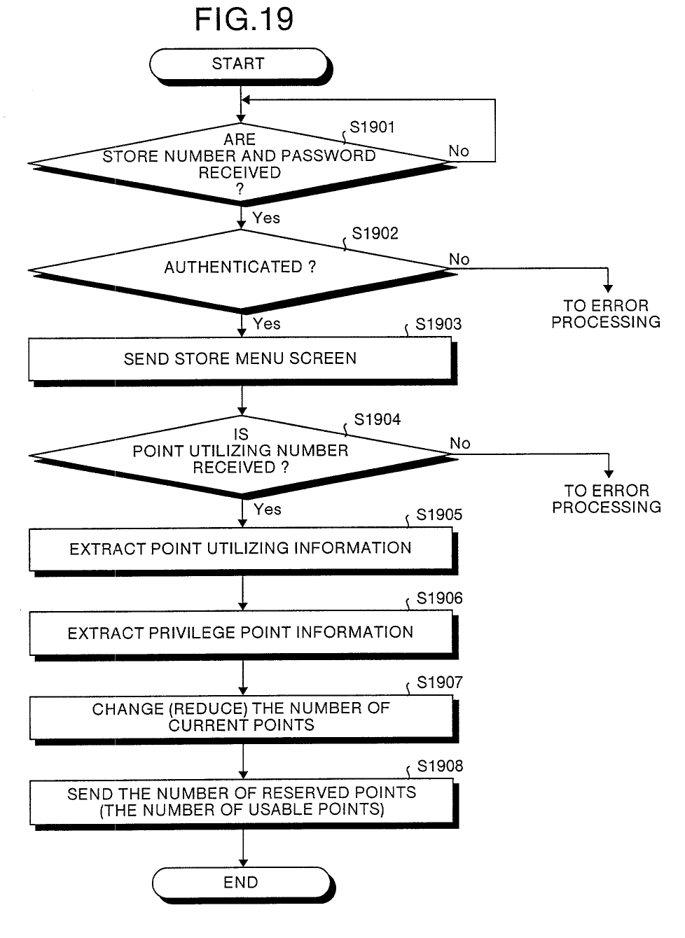

FIG. 19 is a flowchart which shows another procedure of the point server 105 in the privilege point utilizing processing. In the flowchart of FIG. 19, it is judged whether the store number and the password are received (step S1901). This step is repeated until the store number and the password are received. When the store number and the password are received (step S1901: Yes), authentication processing is carried out based on the received store number and password, and it is judged whether the member is an authentic member (step S1902). If the member is not an authentic member (step S1902: No), normal error processing is carried out. More specifically, an error screen is sent to induce the user to input again.

If it is decided in step S1902 that the member is an authentic member (step S1902: Yes), the store menu screen 1700 shown in FIG. 17 is displayed on the terminal apparatus of the store 101 (step S1903). Then, it is judged whether informing concerning the point utilizing number is received (step S1904). This step is repeated until the informing concerning the point utilizing number is received. When the informing concerning the point utilizing number is received (step S1904: Yes), point utilizing information (the number of points corresponding to the point utilizing number) is extracted (step S1905), and privilege point information (the number of current points) is extracted (step S1906).

Informing concerning the number of current points of the privilege point information is changed such that the number of points corresponding to the point utilizing number is subtracted from the number of current points (step S1907). Thereafter, the number of points corresponding to the subtracted point utilizing number is sent to the user terminal apparatus 103 of the member as the number of reserved points (the number of usable points) (step S1908), and the series of processing concerning the utilization of privilege point is completed.

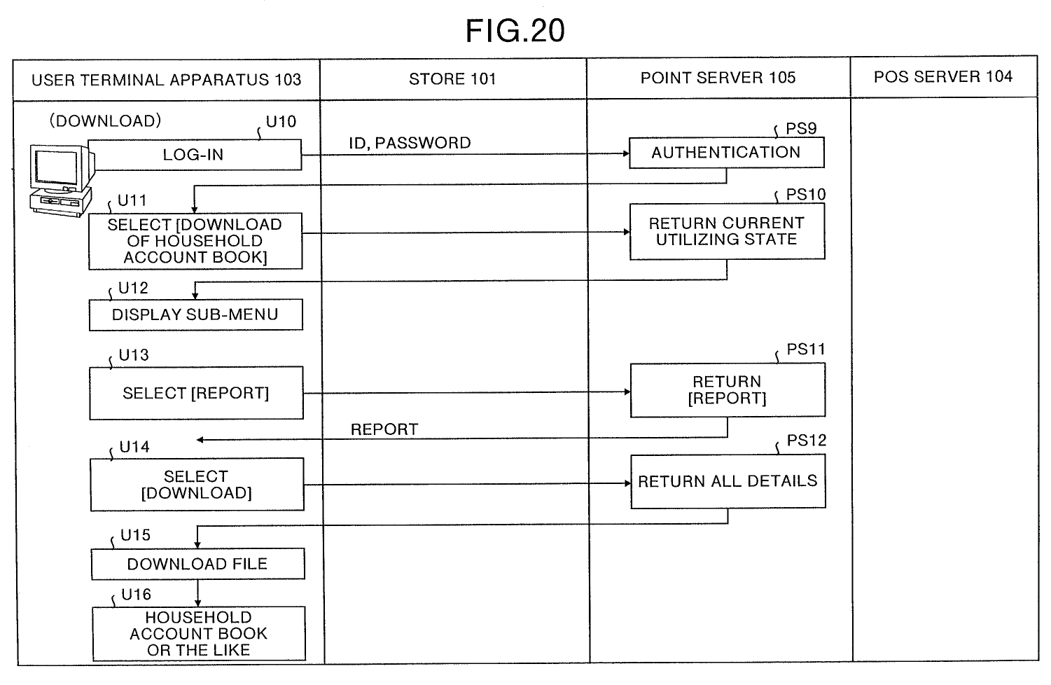

Contents of download processing of the purchase informing according to the embodiment of the invention will be explained. FIG. 20 is an explanatory view which shows the sequence of download processing of the purchase information. In FIG. 20, as procedure of the download processing of the purchase informing, log-in is carried out using the user terminal apparatus 103 (U10). More specifically, by accessing a predetermined site (e.g., [point.com]), a log-in screen 600 shown in FIG. 6 is displayed. Since the contents of the log-in processing is the same as that (U3) shown in FIG. 5, explanation thereof will be omitted.

The authentication processing is carried out in the point.server 105 (PS9). If it is authenticated, the menu screen 700 shown in FIG. 7 is sent to the user terminal apparatus 103, and the menu screen 700 is displayed in the user terminal apparatus 103. Here, the [download household account book] button 704 is selected (U11), and if its informing is received, the point server 105 returns (sends) informing concerning utilizing state to the current time and informing concerning the purchase informing (PS10).

The user terminal apparatus 103 receives the informing and displays a sub-menu (not shown) (U12). Informing concerning the utilization state to the current time, informing concerning purchase statement of the subject store, a [report] button and a [download] button are displayed in the sub-menu. If the [report] button is selected (U13) the selection information is sent to the point server 105.

The point server 105 returns (sends) a report with respect to the received informing (PS11). The report includes a table or graph prepared in a predetermined style from summary of past several months, or comments previously prepared selected concerning purchase state of analysis result.

If the [download] button is selected (U14), the selection information is sent to the point server 105. The point server 105 returns (sends) the informing concerning the entire details of the personal information with respect to the received informing (PS12). At that time, detailed portion which was downloaded may not be sent. With this, it is possible to prevent the informing from being sent twice. The user terminal apparatus 103 receives the informing concerning the entire details of the personal information, and prepares download file (U15), the informing is developed into application such as software of known household account book, and utilized as household account book informing (U16).

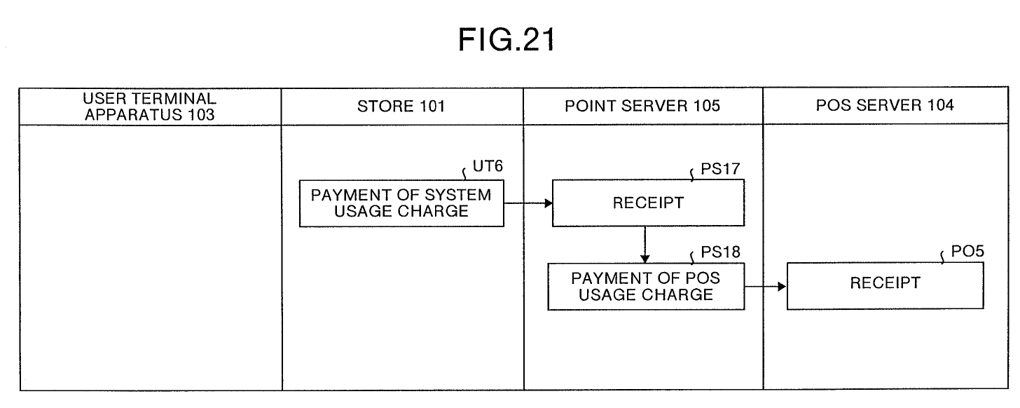

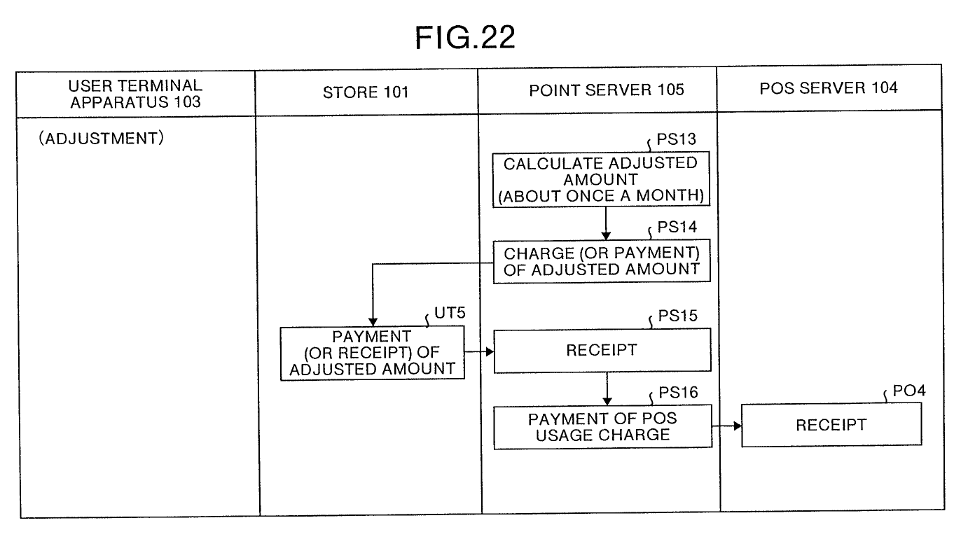

Contents of the adjusting processing of the privilege point source material in the privilege point managing processing of the embodiment of the invention will be explained. FIGS. 21 and 22 are an explanatory views which show a sequence of adjusting processing of privilege point source material. FIG. 21 shows the adjusting processing of the privilege point source material in a closed point system, i.e., a system in which a privilege point accumulated based on purchase of a commodity or reception of service in a certain store can be utilized only in the same store.

In FIG. 21, the store 101 pays a system usage charge of the privilege point managing system to the point server 105 every predetermined period (UT6). The point server 105 receives the payment from the store 101 (PS17), and pays POS usage charge (PS18). Then, the POS server 104 receives the payment from the point server 105 (PO5).

In this case, a store utilizing the closed point system can not take part in an opened point system. Each store selects one of the closed point system or the later-described opened point system. Since source material does not move between the stores, adjustment money of the source material is not generated. Therefore, store pays only the usage charge of the point system.

FIG. 22 shows adjusting processing of the privilege point source material in the opened point system, i.e., a system in which a privilege point accumulated based on purchase of a commodity or reception of service in a certain store (store A) can be utilized also in another store (store B). As for the opened point system, it is necessary that the store A bears the cost corresponding to the reduced discounted source material. However, transaction is not made directly between the stores A and B. It is not fair that the store A bears all the discounted source material. This is because that it is general to consider that sales is established in the store B thanks to points given by the store A.

Thereupon, the source material is calculated in the following manner. A store which pays the source material can pay arbitrary number of points in accordance with campaign or policy of its own. The issued privilege points can freely be utilized in the alliance company of the opened point system. A store which issued the privilege point pays money corresponding to the point to the point system.

An amount of money to be paid Mp=(price of payment point)

A store which utilized a point receives money corresponding to the point from the point system, but bears a constant source material. A source material burden coefficient p is a ratio of duty of source material burden generated to a company which utilized the point. When the amount of money of the issued point exceeds the amount of utilized money, this amount can be utilized again in the same store and thus, burden ratio is lowered to p2 (p1>p2).

An amount of money to be received Membership register=(point amount of money of the issued point to an amount of utilized money)×(1−P2)+(amount of utilized money exceeding amount of money of the issued point)×(1−P1)

Even if all the points are utilized, the point system can receive money exceeding necessary source material eventually. Concerning this exceeding money, the point server 105 and the POS server 104 receive a portion of the money as cost, and remaining amount is returned to each store in accordance with the number of issued points. Transactions within a constant period are totalized, and an amount of money to be paid to stores within a period is calculated.

In FIG. 22, the point server 105 calculates adjusting money for each of predetermined period (e.g., once a month for example) (PS13). The adjusting money is requested from (or paid to) each store 101 (PS14). Each store 101 pays or receives the adjusting money to or from the point server 105 (UT5). When the store 101 pays the adjusting money, the point server 105 receives the adjusting money (PS15) and pays the POS usage charge to the POS server 104 (PS16) The POS server 104 receives the POS usage charge paid from the point server 105 (PO4).

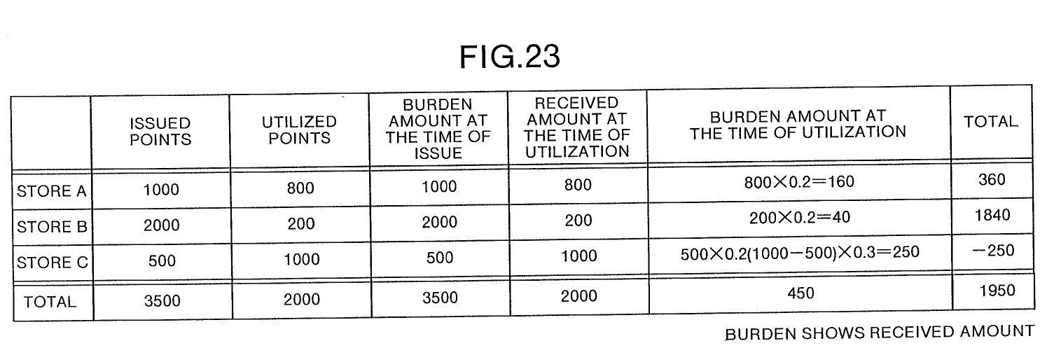

An example of calculation of source material burden will be explained. FIG. 23 is an explanatory view which shows one example of amount of money of primary burden in calculation of source material burden. First, as precondition, a burden ratio at the time of utilization is set to p1=0.3 and p2=0.2, managing cost is set to 1000 yen, and 1 point is set to 1 yen. An amount of money of primary burden of each of the stores (store A, store B and store C) is as shown in FIG. 23. A total of burden amount at the time of issue of the three stores is 3500 (yen), and a total of received amount of money at the time of utilization is 2000 (yen). A total of burden amount of money at the time of utilization of the three stores is 450 (yen) and thus, a total of the amount of money of primary burden of the three stores is 1950 (yen). Breakdown of the three stores is as follows: 360 (yen) for store A, 1840 (yen) for store B and 250 (yen) for store C. The store A and store B pay money, and the store C receives the money.

1000 (yen) which is a point server managing cost is subtracted from a total 1950 (yen) which is amount of money of primary burden,

Money to be returned: 1950 (yen)−1000 (yen)=950 (yen)

The money to be returned is 950 (yen), and this money is returned to the stores in accordance with the number of issued points of the stores. That is,

store A: 950 (yen)×(1000 (yen)÷3500 (yen))=271 (yen)

store B: 950 (yen)×(2000 (yen)÷3500 (yen))=542 (yen)

store C: 950 (yen)×(500 (yen)÷3500 (yen))=135 (yen)

Therefore, the final burden (reception) money is as follows:

store A: 360-271=89 (yen)

store B: 1840-542=1298 (yen)

store C: −250−135=−385 (yen)

As explained above, according to the embodiment, a user 100 him-self or herself can accumulate a privilege point using the personal information processing apparatus 103 after the user bought a commodity or received service. It is possible to make a reservation to use the accumulated privilege point using the user terminal apparatus 103. With this, a store 101 need not issue a point card, and the user 101 need not carry the point card. Therefore, it is possible to effectively manage and utilize the privilege point service by managing the accumulation and utilization of the privilege point easily, efficiently and more reliably.

According to this embodiment, when a user pays money at a checkout, the user only need to receive a receipt, and user may carry out the adjusting processing of the privilege point when user has time. Therefore, it is possible to shorten the speed and enhance the efficiency of register processing. When the privilege point is utilized also, it is possible to previously make a reservation to use the point, congestion at the checkout can be solved. Further, since only points which a user desires to use can be utilized, even if the points are stolen by other person, it is possible to minimize the damage.

Moreover, when the privilege points are accumulated, it is possible to confirm the number of accumulated privilege points. Thus, an instance in which the privilege points are not used and forgotten is avoided, and the points can be utilized effectively. When a user 100 is informed of the accumulated privilege points, if the user is also informed of advertisement information such as [privilege points are given to you if you accumulate this much], it is possible to sap user 100's buying inclination, and to enhance the sales of the store 101.

Furthermore, the user 100 himself or herself accumulates the privilege point, the processing can reliably be carried out, and the processing is carried out on his or her own authority, it is possible to suppress generation of problem.

Moreover, the privilege points can effectively be utilized without issuing the card. Therefore, the store 101 can get customers, and it is possible to discriminate by issuing/utilizing points which have wide utilizing value. It is unnecessary to develop a point system originally, and it is possible to reduce costs to develop and maintain the system.

Furthermore, a user can download the purchase informing concerning when and where the user bought a commodity into his or her computer with easy operation. By downloading the purchase informing into software of household account book, it is possible to reduce the operation of inputting the purchase informing into the household account book.

Moreover, it is possible to get a user as a point portal. That is, since processing including accumulation, usage and download of point can be carried out from one portal screen, it can be ranked as a portal which collect a large number of users. A user of the point server 105 can expect usage charge in issue of point, and can expect advertisement rate as a portal system. It is possible to grasp consumption tendency of user from a large volume of purchase data. A manager of the POS server 104 can expect usage charge of POS, and can apply the charge to liaison between group companies.

As another embodiment, membership register (log-in) at the time of accumulation of points can be omitted. That is, if all the privilege point information is stored in the client side (i.e., user terminal apparatus 103), membership register (log-in) at the time of accumulation of points is unnecessary. Therefore, it is possible to reduce time and cost to connect to the point server 105.

As still another embodiment, the membership register when points are utilized may be omitted. That is, if log informing when points are accumulated or utilized is set on the side of a client and electronic signature is carried out from the point server 105 with respect to this data, the membership register when points are utilized is unnecessary, and the anonymity level as that of the point card can be maintained.

As still another embodiment, deputy processing of user registration capable of completing all processing only by accumulating the points may be carried out for commodity which needs user registration such as software.

As still another embodiment, it is possible to obtain customer informing across stores in association with data warehouse, and to utilize the information of marketing. The informing may be utilized for advertisement of new commodity.

The privilege point managing method of the embodiment may be a previously prepared program which can be read by a computer, and is realized by executing the program by a computer such as a personal computer or a workstation. This program is stored in a storage medium such as HD (hard disk) FD (floppy disk), CD-ROM, MO, DVD and the like which can be read by a computer. This program may be a transmitting medium which can be distributed through network such as the Internet.

As explained above, according to the invention, a user him-self or herself can accumulate the privilege points using the personal information processing apparatus after the user bought a commodity or received service. Therefore, it is possible to make a reservation to use the accumulated privilege point using the user terminal apparatus. As a result, there is obtained an effect that it is possible to provide a privilege point managing method, a privilege point managing program and a privilege point managing apparatus in which a store need not issue a point card, and the user need not carry the point card. Therefore, it is possible to effectively manage and utilize the privilege point service by managing the accumulation and utilization of the privilege point easily, efficiently and more reliably.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A privilege point managing method of accumulating and managing privilege points that are obtained by a user when the user buys a commodity or receives a service and of giving various privileges to the user in accordance with the number of accumulated points, the method comprising:
inputting personal information of the user and receipt ID information described in a receipt obtained by the user when the user buys the commodity or receives the service;
obtaining privilege point information of the user based on the input personal information of the user, and obtaining privilege point information of the receipt based on the input receipt ID information; and
changing the privilege point information of the user based on the privilege point information of the receipt.

2. The privilege point managing method according to claim 1, further comprising judging whether the obtained privilege point information of the user has been changed based on the privilege point information of the receipt, and the obtained privilege point information of the user is changed based on a result of the judgment.

3. The privilege point managing method according to claim 1 or 2, further comprising informing the changed privilege point information to the user.

4. A privilege point managing method of accumulating and managing privilege points that are obtained by a user when the user buys a commodity or receives a service and of giving various privileges to the user in accordance with the number of accumulated points, the method comprising:
inputting personal information of the user;
obtaining privilege point information of the user based on the input personal information;
informing the user of the number of usable points based on the obtained privilege point information of the user;
inputting use-desiring information including the number of points that the user desires to use within a limit of the number of usable points; and
issuing privilege point utilizing ID information that corresponds to the input use-desiring information.

5. The privilege point managing method according to claim 4, further comprising:
inputting the issued privilege point utilizing ID information; and
changing the obtained privilege point information of the user based on the input use-desiring information corresponding to the privilege point utilizing ID information.

6. A computer program containing instructions which when executed on a computer causes the computer to realize a privilege point managing method of accumulating and managing privilege points that are obtained by a user when the user buys a commodity or receives a service and of giving various privileges to the user in accordance with the number of accumulated points, the method comprising:
inputting personal information of the user and receipt ID information described in a receipt obtained by the user when the user buys the commodity or receives the service;
obtaining privilege point information of the user based on the input personal information of the user, and obtaining privilege point information of the receipt based on the input receipt ID information; and
changing the privilege point information of the user based on the privilege point information of the receipt.

7. A privilege point managing program according to claim 6, wherein the privilege point managing method further comprises judging whether the obtained privilege point information of the user has been changed based on the privilege point information of the receipt, and the obtained privilege point information of the user is changed based on a result of the judgment.

8. A privilege point managing program according to claim 6 or 7, wherein the privilege point managing method further comprises informing the changed privilege point information to the user.

9. A computer program containing instructions which when executed on a computer causes the computer to realize a privilege point managing method of accumulating and managing privilege points that are obtained by a user when the user buys a commodity or receives a service and of giving various privileges to the user in accordance with the number of accumulated points, the method comprising:
inputting personal information of the user;
obtaining privilege point information of the user based on the input personal information;
informing the user of the number of usable points based on the obtained privilege point information of the user;
inputting use-desiring information including the number of points that the user desires to use within a limit of the number of usable points; and
issuing privilege point utilizing ID information that corresponds to the input use-desiring information.

10. The privilege point managing program according to claim 9, wherein the privilege point managing method further comprises:
inputting the issued privilege point utilizing ID information; and
changing the obtained privilege point information of the user based on the input use-desiring information corresponding to the privilege point utilizing ID information.

11. A privilege point managing apparatus which manages privilege points that are obtained by a user when the user buys a commodity or receives a service and of giving various privileges to the user in accordance with the number of accumulated points, the apparatus comprising:
a receiving unit which receives personal information of the user and receipt ID information described in a receipt obtained by the user when the user buys the commodity or receives the service;
a user privilege point information obtaining unit which obtains privilege point information of the user based on the input personal information of the user;
a receipt privilege point information obtaining unit which obtains privilege point information of the receipt based on the input receipt ID information; and
a point information changing unit which changes the privilege point information of the user based on the privilege point information of the receipt.

12. The privilege point managing apparatus according to claim 11, further comprising a judging unit which judges whether the obtained privilege point information of the user has been changed based on the privilege point information of the receipt, and
said point information changing unit changes the obtained privilege point information of the user based on a result of the judgment by said judging unit.

13. The privilege point managing method according to claim 11 or 12, further comprising an informing unit which informs the changed privilege point information to the user.

14. A privilege point managing apparatus which manages privilege points that are obtained by a user when the user buys a commodity or receives a service and of giving various privileges to the user in accordance with the number of accumulated points, the apparatus comprising:
a personal information receiving unit which receives personal information of the user;
a privilege point information obtaining unit which obtains privilege point information of the user based on the input personal information;
an informing unit which informs the user of the number of usable points based on the obtained privilege point information of the user;
a use-desiring information receiving unit which receives use-desiring information including the number of points that the user desires to use within a limit of the number of usable points; and
an issuing unit which issues privilege point utilizing ID information that corresponds to the input use-desiring information.

15. The privilege point managing apparatus according to claim 14, further comprising:
a privilege point utilizing ID information receiving unit which receives the issued privilege point utilizing ID information; and
a point information changing unit which changes the obtained privilege point information of the user based on the input use-desiring information corresponding to the privilege point utilizing ID information.
